(19) United States
(12) Patent Application Publication
(10) Pub. No.: US 2018/0137422 A1
(43) Pub. Date: May 17, 2018

(54) FAST LOW-MEMORY METHODS FOR BAYESIAN INFERENCE, GIBBS SAMPLING AND DEEP LEARNING

(71) Applicant: Microsoft Technology Licensing, LLC, Redmond, WA (US)

(72) Inventors: Nathan Wiebe, Redmond, WA (US); Ashish Kapoor, Kirkland, WA (US); Krysta Svore, Seattle, WA (US); Christopher Granade, Sydney (AU)

(73) Assignee: Microsoft Technology Licensing, LLC, Redmond, WA (US)

(21) Appl. No.: 15/579,190

(22) PCT Filed: May 18, 2016
(86) PCT No.: PCT/US2016/032942

§ 371 Date: Dec. 1, 2017

Related U.S. Application Data
(60) Provisional application No. 62/171,195, filed on Jun. 4, 2015.

(51) Int. Cl. G06N 5/02; G06N 7/00; G06N 99/00

(52) U.S. Cl. CPC G06N 5/022; G06N 7/005; G06K 9/6256; G06N 99/002; G06N 99/005

(57) ABSTRACT

Methods of training Boltzmann machines include rejection sampling to approximate a Gibbs distribution associated with layers of the Boltzmann machine. Accepted sample values obtained using a set of training vectors and a set of model values associate with a model distribution are processed to obtain gradients of an objective function so that the Boltzmann machine specification can be updated. In other examples, a Gibbs distribution is estimated or a quantum circuit is specified so at to produce eigenphases of a unitary.

### FIELD

The disclosure pertains to training Boltzmann machines.

### BACKGROUND

Deep learning is a relatively new paradigm for machine learning that has substantially impacted the way in which classification, inference and artificial intelligence (AI) tasks are performed. Deep learning began with the suggestion that in order to perform sophisticated AI tasks, such as vision or language, it may be necessary to work on abstractions of the initial data rather than raw data. For example, an inference engine that is trained to detect a car might first take a raw image and decompose it first into simple shapes. These shapes could form the first layer of abstraction. These elementary shapes could then be grouped together into higher level abstract objects such as bumpers or wheels. The problem of determining whether a particular image is or is not a car is then performed on the abstract data rather than the raw pixel data. In general, this process could involve many levels of abstraction.

Deep learning techniques have demonstrated remarkable improvements such as up to 30% relative reduction in error rate on many typical vision and speech tasks. In some cases, deep learning techniques approach human performance, such as in matching two faces. Conventional classical deep learning methods are currently deployed in language models for speech and search engines. Other applications include machine translation and deep image understanding (i.e., image to text representation).

Existing methods for training deep belief networks use contrastive divergence approximations to train the network layer by layer. This process is expensive for deep networks, relies on the validity of the contrastive divergence approximation, and precludes the use of intra-layer connections. The contrastive divergence approximation is inapplicable in some applications, and in any case, contrastive divergence based methods are incapable of training an entire graph at once and instead rely on training the system one layer at a time, which is costly and reduces the quality of the model. Finally, further crude approximations are needed to train a full Boltzmann machine, which potentially has connections between all hidden and visible units and may limit the quality of the optima found in the learning algorithm. Approaches are needed that overcome these limitations.

### SUMMARY

Methods of Bayes inference, training Boltzmann machines, and Gibbs sampling, and methods for other applications use rejection sampling in which a set of N samples is obtained from an initial distribution that is typically chosen so as to approximate a final distribution and be readily sampled. A corresponding set of N samples based on a model distribution is obtained, wherein N is a positive integer. A likelihood ratio of an approximation to the model distribution over the initial distribution is compared to a random variable, and samples are selected from the set of samples based on the comparison. In a representative application, a definition of a Boltzmann machine that includes a visible layer and at least one hidden layer with associated weights and biases is stored. At least one of the Boltzmann machine weights and biases is updated based on the selected samples and a set of training vectors.

These and other features of the disclosure are set forth below with reference to the accompanying drawings.

### BRIEF DESCRIPTION OF DRAWINGS

FIG. 1 illustrates a representative example of a deep Boltzmann machine.

FIG. 2 illustrates a method of training a Boltzmann machine using rejection sampling.

FIGS. 3A-3B illustrate representative differences between objective functions computed using RS and single step contrastive divergence (CD-1), respectively.

FIG. 4 illustrates a method of obtaining gradients for use in training a Boltzmann machine.

FIG. 5 illustrates a method of training a training a Boltzmann machine by processing training vectors in parallel.

FIG. 6 illustrates rejection sampling based on a mean-field approximation.

FIG. 7 illustrates a method of determining a posterior probability using rejection sampling.

FIG. 8 illustrates rejection sampling based on a mean-field approximation.

FIG. 9 illustrates a quantum circuit.

FIG. 10 illustrates a representative processor-based quantum circuit environment for Bayesian phase estimation.

FIG. 11 illustrates a representative classical computer that is configured to train Boltzmann machines using rejection sampling.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest”, “best”, “minimum,” or the like. It will be appreciated that such descriptions are intended to indicate that a selection among many functional alternatives can be made, and such selections need not be better, smaller, or otherwise preferable to other selections.

The methods and apparatus described herein generally use a classical computer coupled to train a Boltzmann machine. In order for the classical computer to update a model for a Boltzmann machine given training data, a classically tractable approximation to the state provided by a mean field approximation, or a related approximation, is used.

### Boltzmann Machines

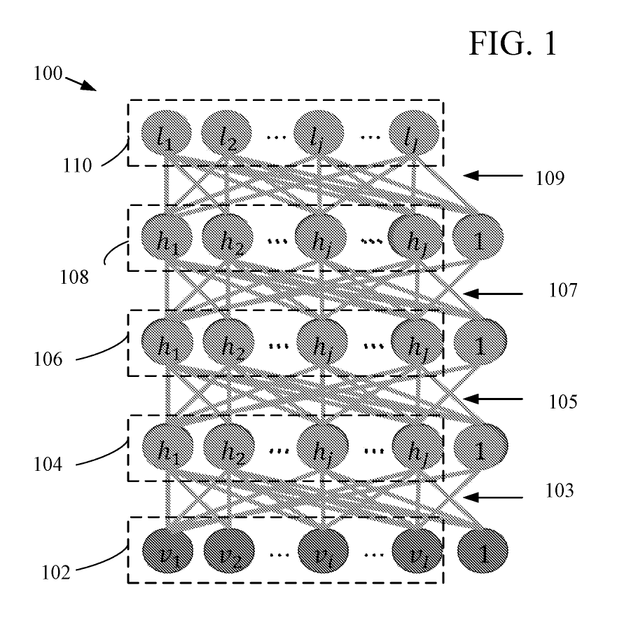

The Boltzmann machine is a powerful paradigm for machine learning in which the problem of training a system to classify or generate examples of a set of training vectors is reduced to the problem of energy minimization of a spin system. The Boltzmann machine consists of several binary units that are split into two categories: (a) visible units and (b) hidden units. The visible units are the units in which the inputs and outputs of the machine are given. For example, if a machine is used for classification, then the visible units will often be used to hold training data as well as a label for that training data. The hidden units are used to generate correlations between the visible units that enable the machine either to assign an appropriate label to a given training vector or to generate an example of the type of data that the system is trained to output. FIG. 1 illustrates a deep Boltzmann machine 100 that includes a visible input layer 102 for inputs vᵢ, and output layer 110 for outputs lⱼ, and hidden unit layers 104, 106, 108 that couple the visible input layer 102 and the visible output layer 104. The layers 102, 104, 106, 108, 110 can be connected to an adjacent layer with connections 103, 105, 107, 109 but in a deep Boltzmann machine such as shown in FIG. 1, there are no intralayer connections. However, the disclosed methods and apparatus can be used to train Boltzmann machines with such intralayer connections, but for convenient description, training of deep Boltzmann machines is described in detail.

Formally, the Boltzmann machine models the probability of a given configuration (v,h) of hidden and visible units via the Gibbs distribution:

P(v,h)=e^{-E(v,h)}/Z,

wherein Z is a normalizing factor known as the partition function, and v,h refer to visible and hidden unit values, respectively. The energy E of a given configuration of hidden and visible units is of the form:

$$E ( v , h ) = {\sum }_{i} {v}_{i} {b}_{i} - {\sum }_{j} {h}_{j} {d}_{j} - {\sum }_{i , j} {w}_{ij} {v}_{i} {h}_{j} ,$$

wherein vectors v and h are visible and hidden unit values, vectors b and d are biases that provide an energy penalty for a bit taking a value of 1 and w_{i,j} is a weight that assigns an energy penalty for the hidden and visible units both taking on a value of 1. Training a Boltzmann machine reduces to estimating these biases and weights by maximizing the log-likelihood of the training data. A Boltzmann machine for which the biases and weights have been determined is referred to as a trained Boltzmann machine. A so-called L2-regularization term can be added in order to prevent overfitting, resulting in the following form of an objective function:

$${O}_{ML} := \frac{1}{{N}_{train}} {\sum }_{v ∈ {x}_{train}} log ( {\sum }_{h} P ( v , h ) ) - \frac{λ}{2} {w}^{T} w .$$

This objective function is referred to as a maximum likelihood-objective (ML-objective) function and λ represents the regularization term. Gradient descent provides a method to find a locally optimal value of the ML-objective function. Formally, the gradients of this objective function can be written as:

$$\begin{matrix}\frac{\partial {O}_{ML}}{\partial {w}_{ij}} = {〈 {v}_{i} {h}_{j} 〉}_{data} - {〈 {v}_{i} {h}_{j} 〉}_{model} - λ {w}_{i , j} & ( 1 a ) \\ \frac{\partial {O}_{ML}}{\partial {b}_{i}} = {〈 {v}_{i} 〉}_{data} - {〈 {v}_{i} 〉}_{model} & ( 1 b ) \\ \frac{\partial {O}_{ML}}{\partial {d}_{j}} = {〈 {h}_{j} 〉}_{data} - {〈 {h}_{j} 〉}_{model} . & ( 1 c )\end{matrix}$$

The expectation values for a quantity x(v,h) are given by:

$${〈 x 〉}_{data} = \frac{1}{{N}_{train}} {\sum }_{v ∈ {x}_{train}} {\sum }_{h} \frac{x ( v , h ) {e}^{- E ( v , h )}}{{Z}_{v}} , wherein$$

$${Z}_{v} = {\sum }_{h} {e}^{- E ( v , h )} , and$$

$${〈 x 〉}_{model} = {\sum }_{v , h} \frac{x ( v , h ) {e}^{- E ( v , h )}}{Z} , wherein$$

$$Z = {\sum }_{v , h} {e}^{- E ( {v}_{data} , h )} .$$

Note that it is non-trivial to compute any of these gradients: the value of the partition function Z is #P-hard to compute and cannot generally be efficiently approximated within a specified multiplicative error. This means modulo reasonable complexity theoretic assumptions, neither a quantum nor a classical computer should be able to directly compute the probability of a given configuration and in turn compute the log-likelihood of the Boltzmann machine yielding the particular configuration of hidden and visible units.

In practice, approximations to the likelihood gradient via contrastive divergence or mean-field assumptions have been used. These conventional approaches, while useful, are not fully theoretically satisfying as the directions yielded by the approximations are not the gradients of any objective function, let alone the log-likelihood. Also, contrastive divergence does not succeed when trying to train a full Boltzmann machine which has arbitrary connections between visible and hidden units. The need for such connections can be mitigated by using a deep restricted Boltzmann machine (shown in FIG. 1) which organizes the hidden units in layers, each of which contains no intra-layer interactions or interactions with non-consecutive layers. The problem with this is that conventional methods use a greedy layer by layer approach to training that becomes costly for very deep networks with a large number of layers.

Boltzmann machines can be used in a variety of applications. In one application, data associated with a particular image, a series of images such as video, a text string, speech or other audio is provided to a Boltzmann machine (after training) for processing. In some cases, the Boltzmann provides a classification of the data example. For example, a Boltzmann machine can classify an input data example as containing an image of a face, speech in a particular language or from a particular individual, distinguish spam from desired email, or identify other patterns in the input data example such as identifying shapes in an image. In other examples, the Boltzmann machine identifies other features in the input data example or other classifications associated with the data example. In still other examples, the Boltzmann machine preprocesses a data example so as to extract features that are to be provide to a subsequent Boltzmann machine. In typical examples, a trained Boltzmann machine can process data examples for classification, clustering into groups, or simplification such as by identifying topics in a set of documents. Data input to a Boltzmann machine for processing for these or other purposes is referred to as a data example. In some applications, a trained Boltzmann machine is used to generate output data corresponding to one or more features or groups of features associated with the Boltzmann machine. Such output data is referred to as an output data example. For example, a trained Boltzmann machine associated with facial recognition can produce an output data example that is corresponding to a model face.

Disclosed herein are efficient classical algorithms for training deep Boltzmann machines using rejection sampling. Error bounds for the resulting approximation are estimated and indicate that choosing an instrumental distribution to minimize an α=2 divergence with the Gibbs state minimizes algorithmic complexity. The disclosed approaches can be parallelized.

A quantum form of rejection sampling can be used for training Boltzmann machines. Quantum states that crudely approximate the Gibbs distribution are refined so as to closely mimic the Gibbs distribution. In particular, copies of quantum analogs of the mean-field distribution are distilled into Gibbs states. The gradients of the average log-likelihood function are then estimated by either sampling from the resulting quantum state or by using techniques such as quantum amplitude amplification and estimation. A quadratic speedup in the scaling of the algorithm with the number of training vectors and the acceptance probability of the rejection sampling step can be achieved. This approach has a number of advantages. Firstly, it is perhaps the most natural method for training a Boltzmann machine using a quantum computer. Secondly, it does not explicitly depend on the interaction graph used. This allows full Boltzmann machines, rather than layered restricted Boltzmann machines (RBMs), to be trained. Thirdly, such methods can provide better gradients than contrastive divergence methods. However, available quantum computers are generally limited to fewer than ten units in the graphical model, and thus are not suitable for many practical machine learning problems. Approaches that do not require quantum computations are needed. Disclosed herein are methods and apparatus based on classical computing that retain the advantages of quantum algorithms, while providing practical advantages for training highly optimized deep Boltzmann machines (albeit at a polynomial increase in algorithmic complexity). Using rejection sampling on samples drawn from the mean-field distribution is not optimal, and using product distributions that minimize the α=2 divergence provides dramatically better results if weak regularization is used.

### Rejection Sampling

Rejection sampling (RS) can be used to draw samples from a distribution

$$\frac{P ( x )}{Z} := P ( x ) / {\sum }_{x} P ( x )$$

by sampling instead from an instrumental distribution Q(x) that approximates the Gibbs state and rejecting samples with a probability

$$\frac{P ( x )}{Z κ Q ( x )} ,$$

wherein κ is a normalizing constant introduced to ensure that the rejection probability is well defined. A major challenge faced when training Boltzmann machines is that Z is seldom known. Rejection sampling can nonetheless be applied if an approximation to Z is provided. If Z_{Q}>0 is such an approximation and

$$\frac{P ( x )}{Z κ Q ( x )} \leq 1 ,$$

then samples from

$$\frac{P ( x )}{Z}$$

can be obtained by repeatedly drawing samples from Q and rejecting the samples with probability

$${Pr}_{accept} ( x \vert Q ( x ) , κ , {Z}_{Q} ) = \frac{P ( x )}{{Z}_{Q} Q ( x ) κ} \qquad ( 2 )$$

until a sample is accepted. This can be implemented by drawing y uniformly from the interval [0,1] and accepting x if y≤Pr_{accept}(x|Q(x),κ,Z_{Q}).

In many applications the constants needed to normalize (2) are not known or may be prohibitively large, necessitating approximate rejection sampling. A form of approximate rejection sampling can be used in which κ_{A}<κ such that

$$\frac{P ( x )}{Z {κ }_{A} Q ( x )} > 1$$

for some configurations referred to herein as “bad.” The approximate rejection sampling algorithm then proceeds in the same way as precise rejection sampling except that a sample x will always be accepted if x is bad. This means that the samples yielded by approximate rejection sampling are not precisely drawn from P/Z. The acceptance rate depends on the choice of Q. One approach is to choose a distribution that minimizes the distance between P/Z and Q, however it may not be immediately obvious which distance measure (or more generally divergence) is the best choice to minimize the error in the resultant distribution given a maximum value of κ_{A}. Even if Q closely approximates P/Z for the most probable outcomes it may underestimate P/Z by orders of magnitude for the less likely outcomes. This can necessitate taking a very large value of κ_{A} if the sum of the probability of these underestimated configurations is appreciable. Generally, it can be shown that to minimize the error ε, the sum Σ_{x∈bad}P(x)/Z should be minimized. It can be shown that by choosing Q to minimize the α=2 divergence D₂(P/Z∥Q), the error in the distribution of samples is minimized. Choosing Q to minimize D2 thus reduces κ.

### Approximate Training of Boltzmann Machines

As discussed above, conventional training methods based on contrastive divergence can be computationally difficult, inaccurate, or fail to converge. In one approach, Q is selected as a mean-field approximation in which Q is a factorized probability distribution over all of the hidden and visible units in the graphical model. More concretely, the mean-field approximation for a restricted Boltzmann machined (RBM) is a distribution such that:

$${Q}_{MF} ( v , h ) = ( {\prod }_{i} {{μ}_{i}^{{v}_{i}} ( 1 - {μ}_{i} )}^{1 - {v}_{i}} ) ( {\prod }_{j} {{v}_{j}^{{h}_{j}} ( 1 - {v}_{j} )}^{1 - {h}_{j}} ) ,$$

wherein μᵢ and νⱼ are chosen to minimize KL(Q|P), wherein KL is the Kullback-Leibler (KL) divergence. The parameters μᵢ and νⱼ are called mean-field parameters. In addition,

μⱼ=(1+e^{-b}^{ⱼ}^{-Σ}^{ₖ}^{w}^{ⱼₖ}^{ν}^{ₖ})⁻¹ and

νⱼ=(1+e^{-b}^{ⱼ}^{-Σ}^{ₖ}^{w}^{ⱼₖ}^{μ}^{ₖ})⁻¹.

A mean-field approximation for a generic Boltzmann machine is similar.

Although the mean-field approximation is expedient to compute, it is not theoretically the best product distribution to use to approximate P/Z. This is because the mean-field approximation is directed to minimization of the KL divergence and the error in the resultant post-rejection sampling distribution depends instead on D₂ which is defined for distributions p and q to be

$${D}_{α} ( p \vert \vert q ) = \frac{1}{α ( 1 - α )} {\int }_{x}^{ } α p ( x ) + ( 1 - α ) q ( x ) - {p ( x )}^{α} {q ( x )}^{1 - α} dx .$$

Finding Q_{MF} does not target minimization of D₂ because the α=2 divergence does not contain logarithms; more general methods such as fractional belief propagation can be used to find Q. Product distributions that target minimization of the α=2 divergence are referred to herein as Q_{α=2}. In this case, Q is selected variationally to minimize an upper bound on the log partition function that corresponds to the choice α=2. Representative methods are described in Wiegerinck et al., “Fractional belief propagation,” Adv. Neural Inf. Processing Systems, pages 455-462 (2003), which is incorporated herein by reference.

The log-partition function can be efficiently estimated for any product distribution

$$log ( Z ) \geq log ( {Z}_{Q} ) := {\sum }_{x} Q ( x ) log [ \frac{{e}^{- E ( x )}}{Q ( x )} ] = - 〈 E 〉 - H [ Q ( x ) ] , \qquad ( 3 )$$

wherein H[Q(x)] is the Shannon entropy of Q(x) and [symbol] E [symbol] is the expected energy of the state Q(x). This equality is true if and only if Q(x)=e^{-E(x)}/Z. The estimate is becomes more accurate as Q(x) approaches the Gibbs distribution. If Eqn. (3) is used to estimate the partition function, the mean-field distribution provides a superior estimate as Z_{MF}. Other estimates of the log-partition function can be used.

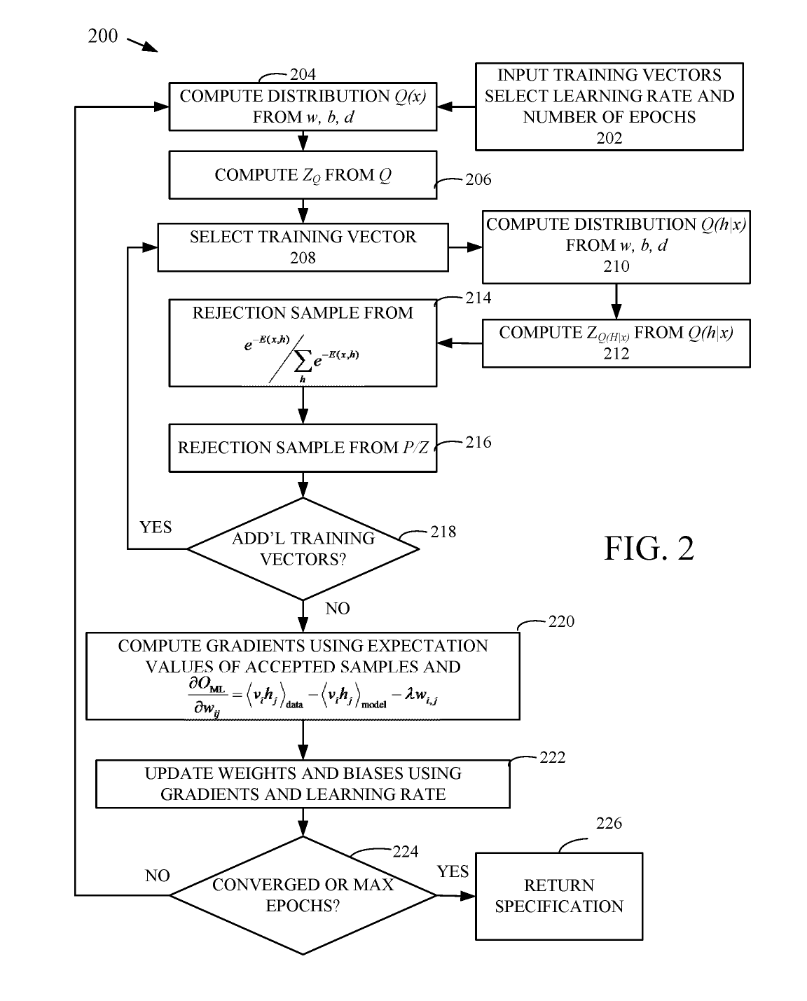

With reference to FIG. 2, a method 200 of training a Boltzmann machine using rejection sampling includes receiving a set of training vectors and establishing a learning rate and number of epochs at 202. In addition, Boltzmann machine design is provided such as numbers of hidden and visible layers. At 204, a distribution Q is computed based on biases b and d and weights w. At 206, an estimate Z_{Q} of the partition function is obtained based on the computed distribution Q. At 208, a training vector is obtained from the set of training vectors, and a distribution Q(h|x) is determined from x, w, b, d at 210. At 212, Z_{Q(h|x)} is computed from Q(h|x). Then, at 214, samples from

$$\frac{{e}^{- E ( x , h )}}{{\sum }_{h} {e}^{- E ( x , h )}}$$

with instrumental distribution Q(h|x) and Z_{Q(h|x)κ}_{_{A}} are obtained until a sample is accepted using Eqn. 2 above. At 216, samples from P/Z with instrumental distribution Q and Z_{Qκ}_{_{A}} are obtained until a sample is accepted using Eqn. 2 above. This is repeated until all (or selected) training vectors are used as determined at 218. At 220, gradients are computed using expectation values of accepted samples based on Eqns. 1a-1c. Weights and biases are updated at 222 using a gradient step and the learning rate r. If convergence of the update weights and biases is determined to be acceptable (or a maximum number of epochs has been reached) at 224, training is discontinued and Boltzmann machine weights and biases assigned and returned at 226. Otherwise, processing continues at 204.

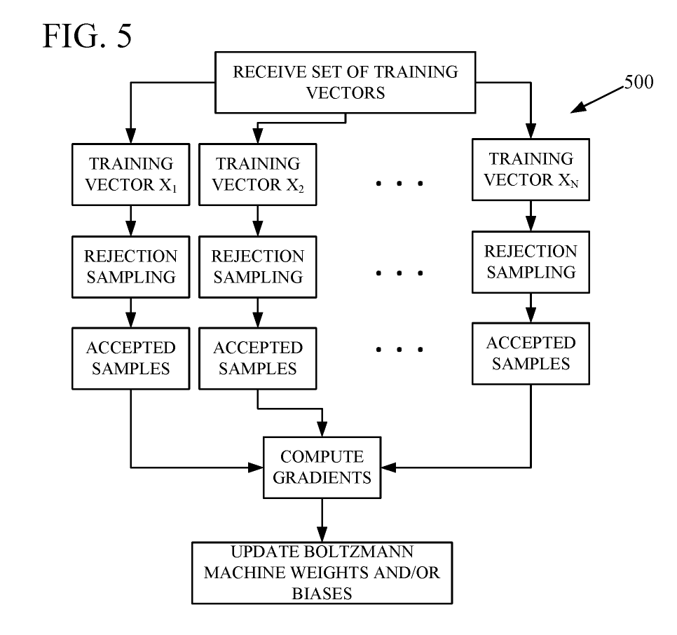

It can be shown that rejection sampling (RS) methods of training such as disclosed herein can be less computationally complex that conventional contrastive divergence (CD) based methods, depending on network depth. In addition, RS-based methods can be parallelized, while CD-based methods generally must be performed serially. For example, as shown in FIG. 5, a method 500 processes some or all training vectors in parallel, and these parallel, RS-based results are used to compute gradients and expectation values so that weights and biases can be updated.

The accuracy of RS-based methods depends on a number of samples used in rejection sampling Q and the value of the normalizing constant κ_{A}. Typically, values of κ_{A} that are greater than or equal to four are suitable, but smaller values can be used. For sufficiently large κ_{A}, error shrinks as

$$O ( \frac{1}{\sqrt{{N}_{samp}}} )$$

where Nₛₐₘₚ is the number of samples used in the estimate of the derivatives. As noted above, a more general product distribution or an elementary non-product distribution can be used instead of a mean-field approximation.

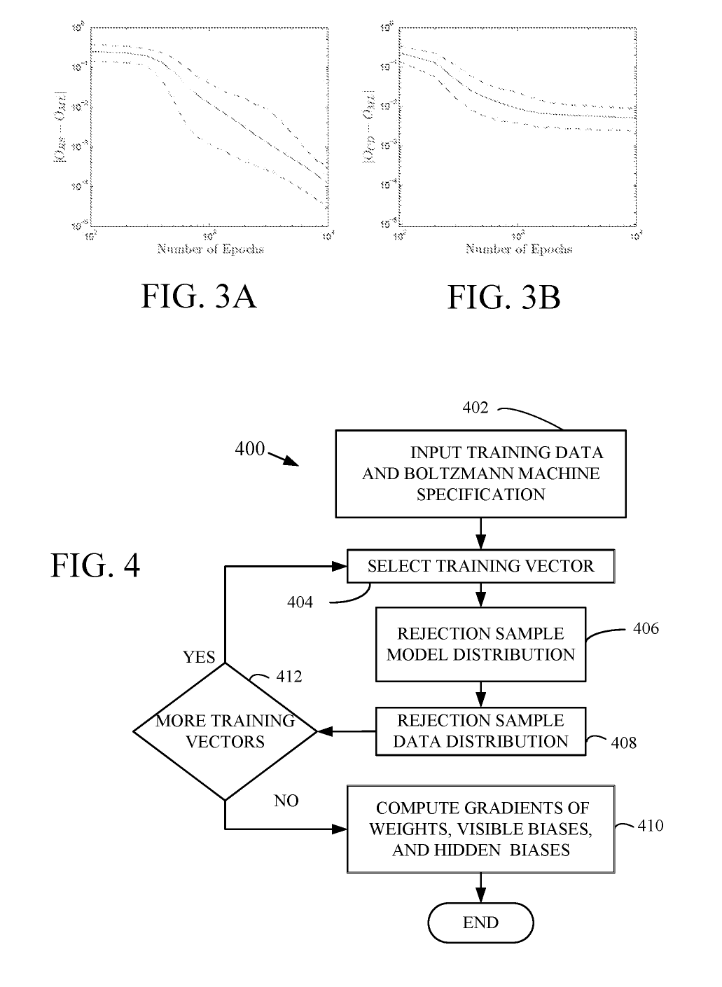

FIGS. 3A-3B illustrate representative differences between objective functions computed using RS and single step contrastive divergence (CD-1), respectively. Dashed lines denote a 95% confidence interval and solid lines denote a mean. For RS, κ_{A}=800, the gradients were taken using 100 samples with 100 training vectors considered and Q was taken to be an even mixture of the mean-field distribution and the uniform distribution. In both cases, λ=0.05 and the learning rate (which is a multiplicative factor used to rescale the computed derivatives) was chosen to shrink exponentially from 0.1 at 1,000 epochs (where an epoch means a step of the gradient descent algorithm) to 0.001 at 10,000 epochs.

As discussed above, rejection sampling can be used to train Boltzmann machines by refining variational approximations to the Gibbs distribution such as the mean-field approximation, into close approximations to the Gibbs state. Cost can be minimized by reducing the α=2 divergence between the true Gibbs state and the instrumental distribution. Furthermore, the gradient yielded by the disclosed methods approaches that of the training objective function as Kκ_{A}→∞ and the costs incurred by using a large KA can be distributed over multiple processors. In addition, the disclosed methods can lead to substantially better gradients than a state of the art algorithm known as contrastive divergence training achieves for small RBMs.

A maximum likelihood objective function can be used in training using a representative method illustrated in Table 1 below.

TABLE 1
RS Method of Obtaining Gradients for Boltzmann Machine Training

```
Input: Initial model weights w, visible biases b, hidden biases d, κ_{A}, a set of training vetors
xₜᵣₐᵢₙ, a regularization term λ, a learning rate r and the functions Q(v, h), [symbol]    (h; v), Z_{Q}, Z_{Q(h;v)}.
Output: gradMLw, gradMLb, gradMLd.
  for i = 1: Nₜᵣₐᵢₙ do
    success ← 0
    while success = 0 do Draw samples from approximate model distribution.
      Draw sample (v, h) from Q(v, h).
      Eₛ ← E(v, h)
      Set success to 1 with probability min(1, e^{-Es}/(Z_{Q}κ_{A}Q(v, h))).
    end while
    mode1V[i] ← v.
    mode1H[i] ← h.
    success ← 0
    v ← xₜᵣₐᵢₙ[i].
    while success = 0 do Draw samples from approximate data distribution.
      Draw sample h from [symbol]    (h; v).
      Eₛ ← E(v, h).
      Set success to 1 with probability min(1, e^{-Es}/(Z_{Q(v,h)}κ_{A} [symbol] (v, h))).
    end while
    dataV[i] ← v.
    dataH[i] ← h.
  end for
  for each visible unit i and hidden unit j do
    $gradMLw [ i , j ] ← r ( \frac{1}{{N}_{train}} {\sum }_{k = 1}^{{N}_{train}} ( data V [ k , i ] data H [ k , j ] - mode 1 V [ k , i ] mode 1 H [ k , j ] ) - λ {w}_{i , j} ) .$
    $gradMLb [ i ] ← r ( \frac{1}{{N}_{train}} {\sum }_{k = 1}^{{N}_{train}} ( data V [ k , i ] - mode 1 V [ k , i ] ) ) .$
    $gradMLd [ j ] ← r ( \frac{1}{{N}_{train}} {\sum }_{k = 1}^{{N}_{train}} ( data H [ k , j ] - mode 1 H [ k , j ] ) ) .$
  end for
```

Approximate model and data distributions Q(v,h), [symbol] ;v), respectively, are sampled via rejection sampling and the accepted samples are used to compute gradients of the weights, visible biases, and hidden biases.

Such a method 400 is further illustrated in FIG. 4. At 402, training data and a Boltzmann machine specification is obtained and stored in a memory. At 404, a training vector is selected and rejection sampling is performed at 406 based on a model distribution. At 408, rejection sampling is applied to a data distribution. If additional training vectors are available as determined at 412, processing returns to 404. Otherwise, gradients are computed at 410.

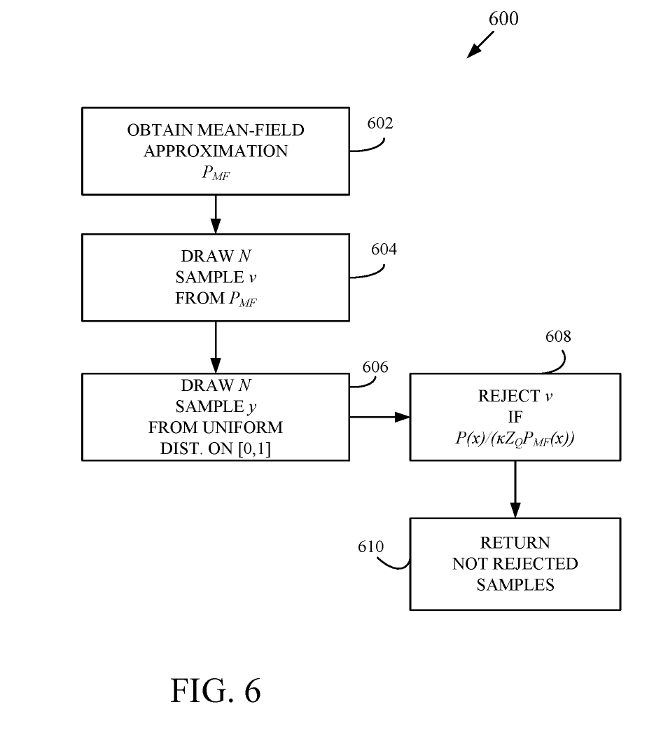

With reference to FIG. 6, a method 600 of rejection sampling includes obtaining a mean-field approximation P_{MF} at 602. The mean field approximation is not necessary, any other tractable approximation can also be used such as a Q(x) that minimizes an □-divergence. At 604, a set of N samples v₁(x), . . . , v_{N}(x) is obtained from P_{MF} for each training vector x of a set of training vectors, wherein N is an integer greater than 1. At 606, a set of N samples u₁(x), . . . , u_{N}(x) is obtained from a uniform distribution on the interval [0, 1]. Other distributions can be used, but a uniform distribution can be convenient. At 608, rejection sampling is performed. A sample v(x) is rejected if P(x)/κZ_{Q}P_{MF}(x)>u(x), wherein κ is a selectable scaling constant that is greater than 1. At 610, accepted samples are returned.

### Bayesian Inference

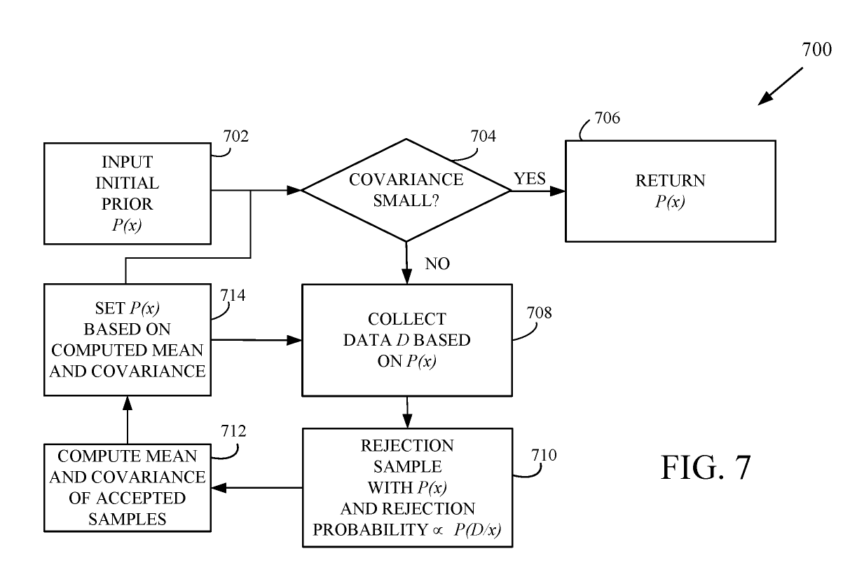

RS as discussed above can also be used to periodically retrofit a posterior distribution to a distribution that can be efficiently sampled. With reference to FIG. 7, a method 700 includes receiving an initial prior probability distribution (initial prior) Pr(x) at 702. Typically, the initial prior Pr(x) is selected from among readily computed distributions such as a sin c function or a Gaussian. At 704, a covariance of the distribution is estimated, and if the covariance is suitably small, the current prior probability distribution (i.e., the initial prior) is returned at 706. Otherwise, sample data D is collected or otherwise obtained at 708. At 710, the sample data D is rejection sampled using (1) based on the initial prior Q(x)=Pr(x), P(x)=Pr(D|x)Pr(x) and the result is re-normalized such that κ_{A}Z_{Q}≈max Pr(D|x). A mean and covariance of accepted samples are computed at 712, and at 714, the model for the updated posterior Pr(x|D) is set based on the mean and covariance of these samples. This revised posterior distribution is can then be evaluated based on a covariance at 704 to determine if additional refinements to Pr(x) are to be obtained. If additional refinements are needed then Pr(x) is set to Pr(x|D) and the updating procedure is repeated until the accuracy target is met or another stopping criteria is reached.

### Sampling from a Gibbs Distribution

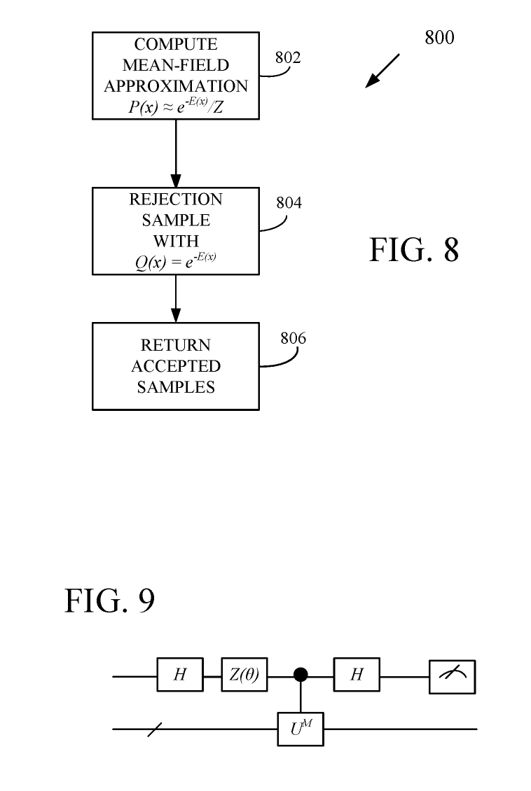

RS as discussed above can also be used to sample from a Gibbs Distribution. Referring to FIG. 8, a method 800 includes computing a mean-field approximation P(x)=e^{-E(x)}/Z at 802, wherein Z is a partition function and E(x) is an energy associated with a sample value x. At 804, rejection sampling is performed with Q(x) taken to be the mean-field approximation or another tractable approximation such as one that minimizes D₂(e^{-E}/Z∥Q). At 806, accepted samples are returned.

### Bayesian Phase Estimation

In quantum computing, determination of eigenphases of a unitary operator U is often needed. Typically, estimation of eigenphases involves repeated application of a circuit such as shown in FIG. 9 in which the value of M is increased and θ is changed to subtract bits that have been obtained. If fractional powers of U can be implemented with acceptable cost, eigenphases can be determined based on likelihood functions associated with the circuit of FIG. 9. The likelihoods for the circuit of FIG. 9 are:

$$P ( 0 \vert ϕ ; θ , M ) = \frac{1 + cos ( M φ + θ )}{2}$$

$$P ( 1 \vert ϕ ; θ , M ) = \frac{1 - cos ( M φ + θ )}{2}$$

If the prior mean is μ and the prior standard deviation is σ, then

$$M = 1.25 \text{/} σ and - ( \frac{θ}{M} ) \text{∼} P ( φ ) .$$

The constant factor 1.25 is based on optimizing median performance of the method. In some cases, the computation of σ depends on the interval that is available for θ (for example, [0, 2π] it may be desirable to shift the interval to reduce the effects of wrap around.

In some cases, the likelihoods above vary due to decoherence. With a decoherence time T₂, the likelihoods are:

$$P ( 0 \vert ϕ ; θ , M ) = {e}^{- M / {T}_{2}} [ \frac{1 + cos ( M φ + θ )}{2} ] + \frac{1 - {e}^{- M / {T}_{2}}}{2}$$

$$P ( 1 \vert ϕ ; θ , M ) = {e}^{- M / {T}_{2}} [ \frac{1 - cos ( M φ + θ )}{2} ] + \frac{1 - {e}^{- M / {T}_{2}}}{2} .$$

A method for selecting M, θ with such decoherence is summarized in Table 2. Inputs: Prior RS sample state mean μ and covariance Σ and sampling kernel F.

M←1/\sqrt{Tr(Σ)}

if M≥T₂,then

M˜f(x;1/T₂)(draw M from exponential distribution with mean T₂)

−(θ/M)˜F(μ,Σ)

return M,θ
Table 2. Pseudocode for estimating M, θ with decoherence.

An exponential distribution is used in Table 2 as such a distribution corresponds to exponentially decaying probability. Other distributions such as a Gaussian distribution can be used as well. In some cases, to avoid possible instabilities, multiple events can be batched together in a single step to form an effective likelihood function of the form:

$$P ( E \vert {x}_{1 ,} {x}_{2} , … , {x}_{p} ) = {\prod }_{j = 1}^{p} p ( E \vert {x}_{j} )$$

### Quantum and Classical Processing Environments

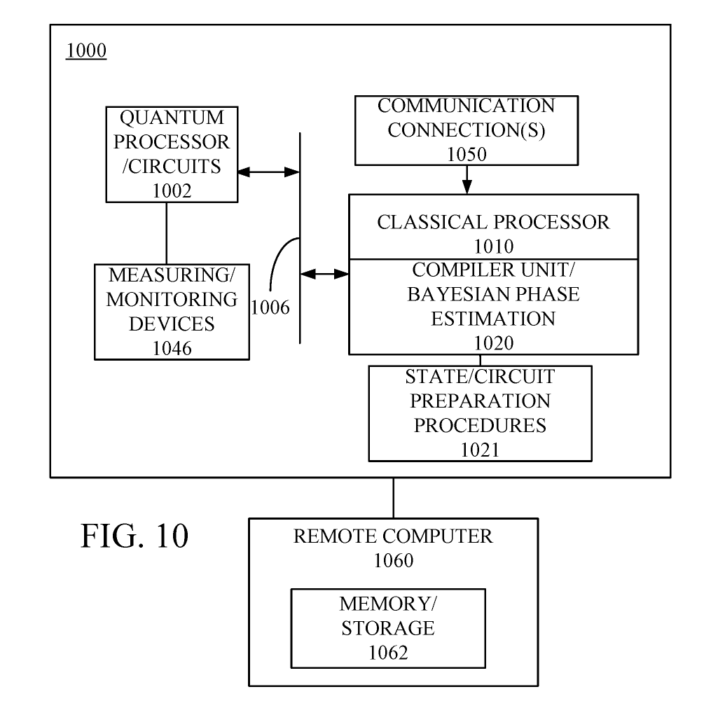

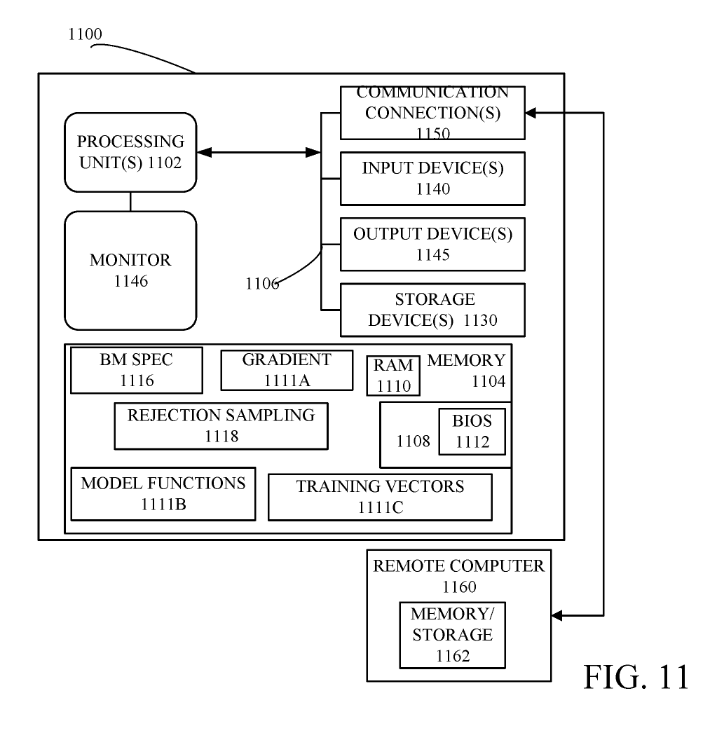

With reference to FIG. 10, an exemplary system for implementing some aspects of the disclosed technology includes a computing environment 1000 that includes a quantum processing unit 1002 and one or more monitoring/measuring device(s) 1046. The quantum processor executes quantum circuits (such as the circuit of FIG. 9) that are precompiled by classical compiler unit 1020 utilizing one or more classical processor(s) 1010.

With reference to FIG. 10, the compilation is the process of translation of a high-level description of a quantum algorithm into a sequence of quantum circuits. Such high-level description may be stored, as the case may be, on one or more external computer(s) 1060 outside the computing environment 1000 utilizing one or more memory and/or storage device(s) 1062, then downloaded as necessary into the computing environment 1000 via one or more communication connection(s) 1050. Alternatively, the classical compiler unit 1020 is coupled to a classical processor 1010 and a procedure library 1021 that contains some or all procedures or data necessary to implement the methods described above such as RS-sampling based phase estimation, including selection of rotation angles and fractional (or other exponents) used a circuits such as that of FIG. 9.

FIG. 11 and the following discussion are intended to provide a brief, general description of an exemplary computing environment in which the disclosed technology may be implemented. Although not required, the disclosed technology is described in the general context of computer executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices. Typically, a classical computing environment is coupled to a quantum computing environment, but a quantum computing environment is not shown in FIG. 11.

With reference to FIG. 11, an exemplary system for implementing the disclosed technology includes a general purpose computing device in the form of an exemplary conventional PC 1100, including one or more processing units 1102, a system memory 1104, and a system bus 1106 that couples various system components including the system memory 1104 to the one or more processing units 1102. The system bus 1106 may be any of several types of bus structures including a memory bus or memory controller, a peripheral bus, and a local bus using any of a variety of bus architectures. The exemplary system memory 1104 includes read only memory (ROM) 1108 and random access memory (RAM) 1110. A basic input/output system (BIOS) 1112, containing the basic routines that help with the transfer of information between elements within the PC 1100, is stored in ROM 1108.

As shown in FIG. 11, a specification of a Boltzmann machine (such as weights, numbers of layers, etc.) is stored in a memory portion 1116. Instructions for gradient determination and evaluation are stored at 1111A. Training vectors are stored at 1111C, model function specifications are stored at 1111B, and processor-executable instructions for rejection sampling are stored at 1118. In some examples, the PC 1100 is provided with Boltzmann machine weights and biases so as to define a trained Boltzmann machine that receives input data examples, or produces output data examples. In alternative examples, a Boltzmann machine trained as disclosed herein can be coupled to another classifier such as another Boltzmann machine or other classifier.

The exemplary PC 1100 further includes one or more storage devices 1130 such as a hard disk drive for reading from and writing to a hard disk, a magnetic disk drive for reading from or writing to a removable magnetic disk, and an optical disk drive for reading from or writing to a removable optical disk (such as a CD-ROM or other optical media). Such storage devices can be connected to the system bus 1106 by a hard disk drive interface, a magnetic disk drive interface, and an optical drive interface, respectively. The drives and their associated computer readable media provide nonvolatile storage of computer-readable instructions, data structures, program modules, and other data for the PC 1100. Other types of computer-readable media which can store data that is accessible by a PC, such as magnetic cassettes, flash memory cards, digital video disks, CDs, DVDs, RAMs, ROMs, and the like, may also be used in the exemplary operating environment.

A number of program modules may be stored in the storage devices 1130 including an operating system, one or more application programs, other program modules, and program data. Storage of Boltzmann machine specifications, and computer-executable instructions for training procedures, determining objective functions, and configuring a quantum computer can be stored in the storage devices 1130 as well as or in addition to the memory 1104. A user may enter commands and information into the PC 1100 through one or more input devices 1140 such as a keyboard and a pointing device such as a mouse. Other input devices may include a digital camera, microphone, joystick, game pad, satellite dish, scanner, or the like. These and other input devices are often connected to the one or more processing units 1102 through a serial port interface that is coupled to the system bus 1106, but may be connected by other interfaces such as a parallel port, game port, or universal serial bus (USB). A monitor 1146 or other type of display device is also connected to the system bus 1106 via an interface, such as a video adapter. Other peripheral output devices 1145, such as speakers and printers (not shown), may be included. In some cases, a user interface is display so that a user can input a Boltzmann machine specification for training, and verify successful training.

The PC 1100 may operate in a networked environment using logical connections to one or more remote computers, such as a remote computer 1160. In some examples, one or more network or communication connections 1150 are included. The remote computer 1160 may be another PC, a server, a router, a network PC, or a peer device or other common network node, and typically includes many or all of the elements described above relative to the PC 1100, although only a memory storage device 1162 has been illustrated in FIG. 11. The storage device 1162 can provide storage of Boltzmann machine specifications and associated training instructions. The personal computer 1100 and/or the remote computer 1160 can be connected to a logical a local area network (LAN) and a wide area network (WAN). Such networking environments are commonplace in offices, enterprise wide computer networks, intranets, and the Internet.

When used in a LAN networking environment, the PC 1100 is connected to the LAN through a network interface. When used in a WAN networking environment, the PC 1100 typically includes a modem or other means for establishing communications over the WAN, such as the Internet. In a networked environment, program modules depicted relative to the personal computer 1100, or portions thereof, may be stored in the remote memory storage device or other locations on the LAN or WAN. The network connections shown are exemplary, and other means of establishing a communications link between the computers may be used.

In some examples, a logic device such as a field programmable gate array, other programmable logic device (PLD), an application specific integrated circuit can be used, and a general purpose processor is not necessary. As used herein, processor generally refers to logic devices that execute instructions that can be coupled to the logic device or fixed in the logic device. In some cases, logic devices include memory portions, but memory can be provided externally, as may be convenient. In addition, multiple logic devices can be arranged for parallel processing.

Having described and illustrated the principles of the disclosed technology with reference to the illustrated embodiments, it will be recognized that the illustrated embodiments can be modified in arrangement and detail without departing from such principles. The technologies from any example can be combined with the technologies described in any one or more of the other examples. Alternatives specifically addressed in these sections are merely exemplary and do not constitute all possible examples.

1.-15. (canceled)

16. A method, comprising:
with a processor:
obtaining a set of N samples from an initial distribution, wherein N is a positive integer;
comparing a likelihood ratio of an approximation to a model distribution over the initial distribution to a random variable; and
selecting samples from the set of N samples based on the comparison.

17. The method of claim 16, further comprising producing a final distribution based on the selected samples.

18. The method of claim 17, further comprising:
storing a definition of a Boltzmann machine that includes a visible layer and at least one hidden layer with associated weights and biases;
with the processor, updating at least one of the Boltzmann machine weights and biases based on the selected samples and a set of training vectors.

19. The method of claim 18, wherein the model distribution is selected so as to correspond to a data distribution.

20. The method of claim 19, further comprising:
determining gradients of an objective function associated with each of the weights and biases of the Boltzmann machine based on the selected samples from the data distribution and the model distribution; and
updating the Boltzmann machine weights and biases based on the gradients.

21. The method of claim 20, wherein the gradients of the objective function are determined as
$$\frac{\partial {O}_{ML}}{\partial {w}_{ij}} = {〈 {v}_{i} {h}_{j} 〉}_{data} - {〈 {v}_{i} {h}_{j} 〉}_{model} - λ {w}_{i , j} , \\ \frac{\partial {O}_{ML}}{\partial {b}_{i}} = {〈 {v}_{i} 〉}_{data} - {〈 {v}_{i} 〉}_{model} , and$$
$$\frac{\partial {O}_{ML}}{\partial {d}_{j}} = {〈 {h}_{j} 〉}_{data} - {〈 {h}_{j} 〉}_{model} ,$$
wherein O_{ML} is an objective function, vᵢ and hⱼ are visible and hidden unit values, bᵢ and dⱼ are biases, and w_{i,j} is a weight.

22. The method of claim 20, further comprising receiving a scaling constant, wherein the comparison is based on a ratio of the data distribution to a product of the scaling constant and the model distribution for each sample of the model distribution.

23. An apparatus, comprising:
at least one memory storing a definition of a Boltzmann machine, including numbers of layers, biases associated with hidden and visible layers, and weights;
a processor that is configured to:
obtain a set of samples from a model distribution by rejection sampling, and
based on the obtained set of samples, update at least one of the stored biases and weights of the Boltzmann machine.

24. The apparatus of claim 23, wherein the model distribution is a mean-field distribution, a product distribution that minimizes an α-divergence with a Gibbs state or a linear combination thereof.

25. The apparatus of claim 24, wherein the stored biases and weights are updated based on a gradient associated with at least one of the stored weights and biased using the obtained set of samples.

26. The apparatus of claim 24, wherein the processor receives a set of training vectors, wherein the set of samples from the model distribution is obtained by rejection sampling based on the training vectors.

27. The apparatus of claim 24, wherein the processor obtains the set of samples from the model distribution by rejection sampling.

28. The apparatus of claim 24, wherein the at least one memory stores computer-executable-instructions that cause the processor to obtain the set of samples from the model distribution by rejection sampling and update at least one of the stored biases and weights of the Boltzmann machine.

29. The apparatus of claim 24, wherein the processor is a programmable logic device.

30. A method, comprising:
with a processor,
receiving an initial estimate of a prior probability distribution;
obtaining a data set associated with the prior probability distribution;
accepting samples from the data set based on rejection sampling; and
updating the initial estimate to obtain an estimated posterior probability distribution based on the accepted samples.

31. The method of claim 30, further comprising:
with the processor,
obtaining a data set associated with the estimated prior probability distribution;
accepting samples from the data set based on rejection sampling; and
updating the estimated prior probability distribution based on accepted samples.

32. The method of claim 31, further comprising:
determining a mean and covariance of the accepted samples, wherein one or more of the initial estimates of the prior probability distribution, the estimated posterior probability distribution, or the estimated prior probability distribution is updated based on the determined mean and covariance.

33. The method of claim 30, wherein the processor is configured to receive a scaling constant and the rejection sampling is based on the scaling constant.

34. The method of claim 29, wherein the processor is configured to perform the rejection sampling based on at least two scaling constants, and provide a final estimate from among updated estimates associated with the plurality of scaling constants.

35. The method of claim 30, wherein the prior probability is associated with the eigenvalues of a unitary, and the estimated prior probability distribution is updated so as to determine at least one of the eigenvalues and a rotation angle and an exponent of the unitary that define a quantum circuit that includes a rotation gate based on the determined rotation angle and a controlled gate based on the unitary and the determined exponent.
